(19) United States
(12) Patent Application Publication
(10) Pub. No.: US 2025/0247312 A1
(43) Pub. Date: Jul. 31, 2025

(54) PERFORMANCE INDICATOR ACQUISITION AND PROCESSING FOR A COMMUNICATION NETWORK

(71) Applicant: Verizon Patent and Licensing Inc., Basking Ridge, NJ (US)

(72) Inventors: Randolph Torres, Merritt Island, FL (US); Srinivas Venkatraman, Edison, NJ (US); Michael T. Bayne, Wesley Chapel, FL (US); Corbin P. Moline, Merritt Island, FL (US); Arun Cherla, Basking Ridge, NJ (US); Antra Malhotra, Tampa, FL (US)

(21) Appl. No.: 18/423,386

(22) Filed: Jan. 26, 2024

(51) Int. Cl. H04L 43/06; H04L 43/026

(52) U.S. Cl. CPC H04L 43/06; H04L 43/02; H04L 43/028; H04L 43/04; H04L 43/065; H04L 43/067; H04L 43/08; H04L 43/0817; H04L 43/0894; H04L 43/20; H04L 43/026

(57) ABSTRACT

One or more computing devices, systems, and/or methods for performance indicator acquisition and processing for a communication network are provided. A compiler generates a package with compiler objects specifying how a normalizer is to process performance indicator data from a network element. The package is injected into the normalizer. The normalizer receives incoming performance indicator data from the network element over a message bus. The compiler objects are used to process the incoming performance indicator data to create and persistently store performance indicators records.

### BACKGROUND

A communication network such as a cellular network includes network elements used to facilitate communication over the cellular network. The network elements may include cell towers, base stations, repeaters, mobile switching centers, radio network controllers, a core network, a radio access network, etc. User equipment can connect to the communication network in order to communicate over the communication network with other user equipment, devices, and services. Performance indicators such as key performance indicators may be tracked for the network elements in order to identify and troubleshoot problems such as an overloaded or failed cell tower.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A illustrates an example of a system for performance indicator acquisition and processing for a communication network using a compiler, in accordance with an embodiment of the present technology;

FIG. 1B illustrates an example of a system for performance indicator acquisition and processing for a communication network using a normalizer, in accordance with an embodiment of the present technology;

FIG. 1C illustrates an example of a system for performance indicator acquisition and processing for a communication network using an aggregator, in accordance with an embodiment of the present technology;

FIG. 2 is a flow chart illustrating an example method for performance indicator acquisition and processing for a communication network, in accordance with an embodiment of the present technology;

FIG. 3A illustrates an example of a system for performance indicator acquisition and processing for a communication network, in accordance with an embodiment of the present technology;

FIG. 3B illustrates an example of a system for performance indicator acquisition and processing for a communication network, in accordance with an embodiment of the present technology;

FIG. 3C illustrates an example of a system for performance indicator acquisition and processing for a communication network, in accordance with an embodiment of the present technology;

FIG. 3D illustrates an example of a system for performance indicator acquisition and processing for a communication network by performing a corrective action, in accordance with an embodiment of the present technology;

FIG. 4 is an illustration of example networks that may utilize and/or implement at least a portion of the techniques presented herein;

FIG. 5 is an illustration of a scenario involving an example configuration of a computer that may utilize and/or implement at least a portion of the techniques presented herein;

FIG. 6 is an illustration of a scenario involving an example configuration of a client that may utilize and/or implement at least a portion of the techniques presented herein;

FIG. 7 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

One or more systems and/or techniques for performance indicator acquisition and processing for a communication network are provided. A platform is provided for handling performance data of the communication network such as a cellular network. The performance data may relate to performance indicators such as key performance indicators associated with network elements of the communication network. The performance indicators may include download speeds, upload speeds, voice connects (or failures to connect), text messaging (or failures to send/receive text messages), user equipment performance (e.g., data transfer speeds of a mobile device), cell tower performance, network equipment performance (network element performance), and/or other metrics that can be analyzed to determine performance and operation of the communication network and devices connected thereto.

Performance indicators are acquired, persisted, and/or processed by a platform that includes a compiler, performance data delivery, a normalizer, an aggregator, and/or other components. The platform is configured to be network element agnostic. Any type of network element may be dynamically added or removed (on the fly) during continued operation of the platform acquiring, persisting, and processing performance indicators. Network elements may be added or removed from being tracked by the platform without having to redeploy the platform. Performance indicators may be dynamically added or removed (on the fly) during continued operation of the platform acquiring, persisting, and processing performance indicators without having to redeploy the platform. Similarly, the aggregations (e.g., summations and counts) may be dynamically added or removed (on the fly) during continued operation of the platform.

The platform is agnostic such that streaming functionality, databases, cloud computing environments, and/or other components or services utilized by the platform can be changed without affecting code of the platform and without performing a new deployment of the platform. For example, a new database can be added to the platform and an old database can be removed from the platform without stopping the platform. The platform is fault tolerant to performance data loss because performance data is persisted as performance indicator records that may be redundantly stored within different regions of the communication network for disaster recovery protection. The platform reduces the resources of a database used to store the performance indicator records by utilizing aggregation windows for core aggregations (e.g., aggregating performance indicator data over 1 minute, 15 minutes, hourly, daily, etc.). The platform can be deployed on low-cost hardware and utilize cost effective database technology that can be distributed or non-distributed.

The compiler is configured to add new network elements and support changes and enhancements to existing network elements for tracking performance indicator data of the network elements. The compiler can add, remove, or support changes and enhancements to existing network elements without performing code modifications for the platform and without creating new deployments of the platform. The platform includes performance data delivery that may be implemented as a component (e.g., an application integrated into a network element) that delivers network performance data (performance indicator data) to the platform (e.g., a message bus). The normalizer is configured to normalize and persist the incoming performance indicator data received by the platform over the data delivery component. Information and instructions from the compiler are input into the normalizer (e.g., through packages of compiler objects dynamically injected into the normalizer) during runtime to keep the normalizer up-to-date on what performance indicators to track, process, and persist as performance indicator records. The aggregator is configured to perform aggregations upon the performance indicator records (e.g., Summations and counts upon the incoming performance indicator data) over various aggregation windows such as per minute, 15 minutes, hourly, daily, or any other timeframe.

The performance indicator records may be utilized to perform various corrective actions. In some embodiments, a troubleshooting request may be received (e.g., user equipment may be experiencing dropped calls, text message send errors, voicemail access errors, no service, performance degradation, etc.). Based upon a type of issue to troubleshoot and/or a nature of the troubleshooting request (e.g., a call center attempting to perform real-time troubleshoot; a service ticket to research a problem; an issue that may periodically occur over hours or days; etc.), a particular level of granularity of performance indicator data may be determined. In this way, the aggregator may retrieve an aggregated performance indicator set of performance indicator data that has been aggregated at the particular level of granularity (e.g., aggregated over 1 minute for real-time call center troubleshooting, aggregated hourly or daily for a service ticket to research text message send errors or voicemail access errors that may periodically occur hourly or daily, etc.).

A corrective action may be constructed based upon an evaluation of the aggregated performance indicator set (e.g., performance indicator data may indicate that a cell tower is overloaded or has failed, and is a cause of the user equipment experiencing degraded performance or other issues). In some embodiments, the corrective action describes the cause of the problem and/or includes troubleshooting steps that can be taken by the call center. In some embodiments, the corrective action includes a command that is transmitted over the communication network to a network element for modifying operation of the network element (e.g., a command to a load balancer or other component to redirect connect requests from the problematic cell tower to a healthy cell tower). In this way, the platform is capable of improving the functional operation of the communication network, network elements, and/or user equipment

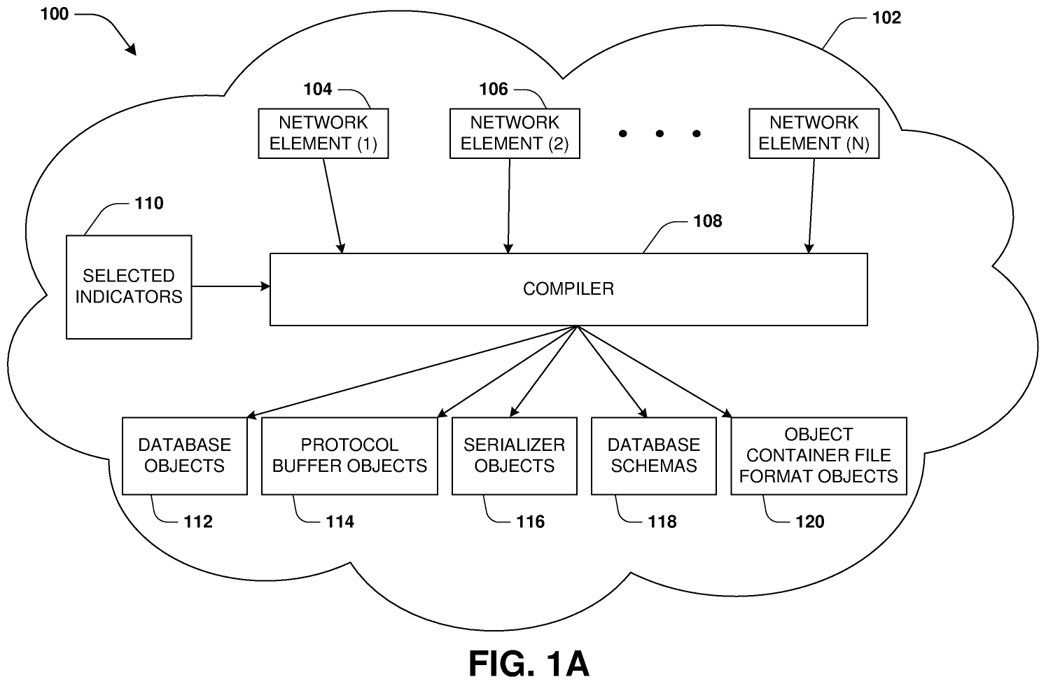

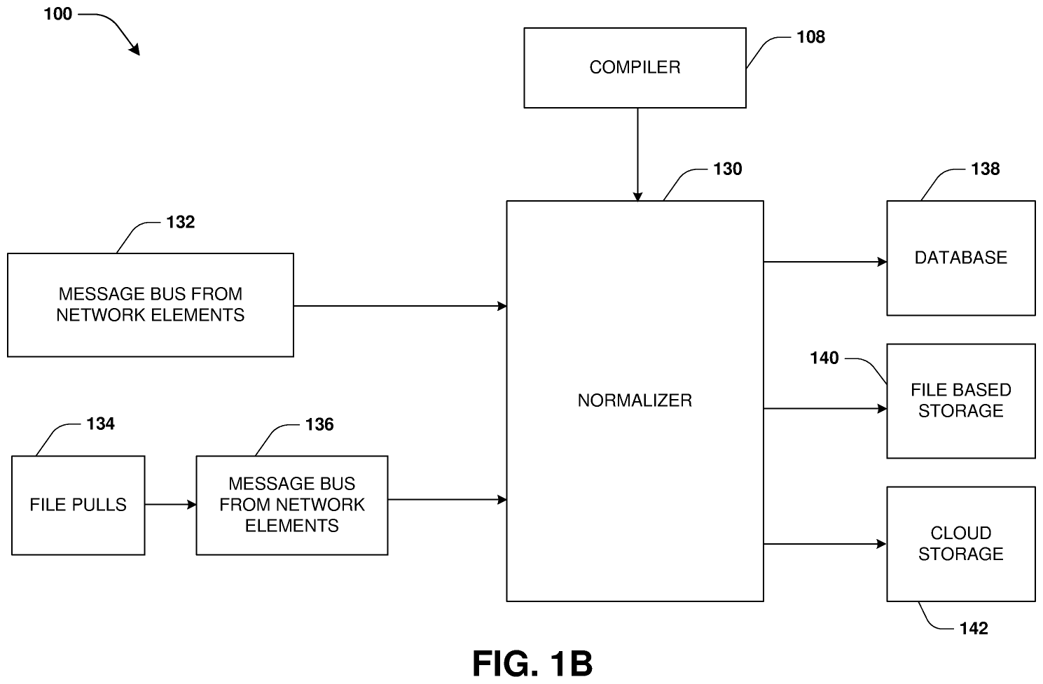

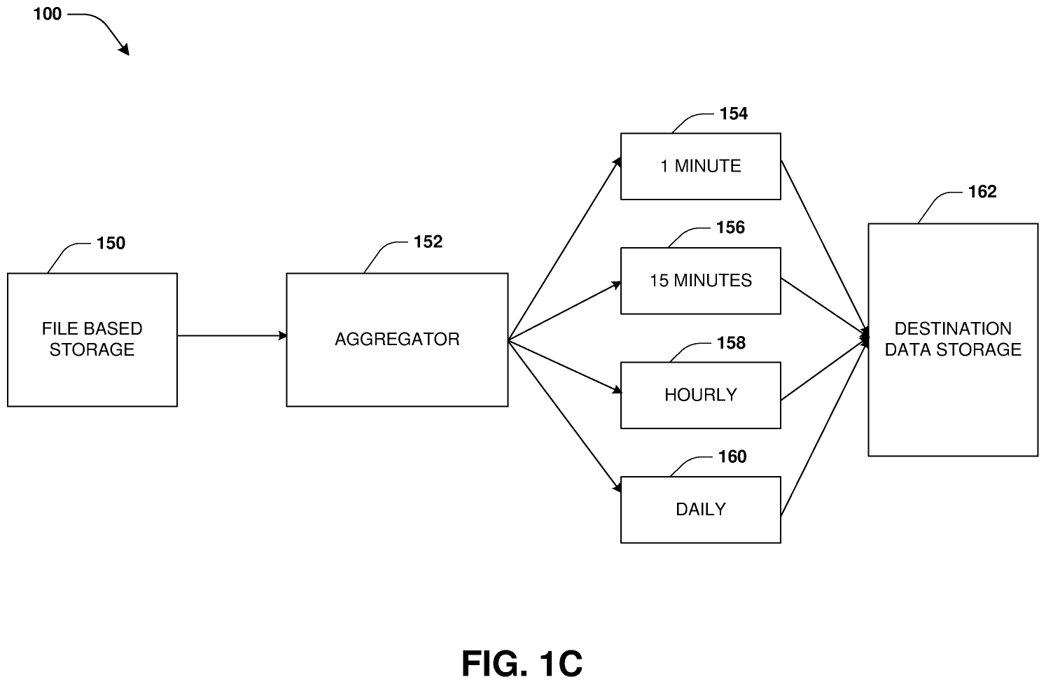

FIGS. 1A-1C illustrate an example of a system 100 for performance indicator acquisition and processing for a communication network 102. The communication network 102 may include network elements, such as a first network element 104, a second network element 106, and/or other network elements (e.g., cell towers, base stations, repeaters, mobile switching centers, radio network controllers, a core network, a radio access network, etc.). For a particular network element, the compiler 108 identifies selected indicators 110 specifying performance indicators (key performance indicators) to track for that network element. Based upon the selected indicators 110, the compiler 108 generates compiler objects specifying how a normalizer 130 (depicted by FIG. 1B) is to process performance indicator data from the network element to generate performance indicator records. The compiler objects enable the normalizer 130 to operate without having to be redeployed, and thus the compiler objects can be used to dynamically reconfigure the normalizer 130 during continued operation of the normalizer 130 to track performance indicators for new network elements and/or change how performance indicators are tracked for existing network elements (e.g., track new performance indicators, stop tracking a performance indicator, processing performance indicators differently, etc.).

The compiler objects may include one or more of database objects 112 (e.g., specifying a format to use for storing data published over a message bus, such as where data is stored on a message bus using various compression technologies for performance), marshaling objects 114 (e.g., specifying a format to use for storing data published over a message bus), serializer objects 116 (e.g., a serialization class for placing messages of incoming performance indicator data onto a message bus), database schemas 118 (e.g., JAVA entities for storage in select types of databases, database schemas for storing messages after normalization, database schemas for storing aggregated values, etc.), object container file format objects 120, and/or other types of objects. In some embodiments, the database objects 112 may be used for certain network elements, and the protocol buffer objects 114 may be used for other network elements.

In some embodiments, the compiler 108 performs various functions such as configuring network elements on the communication network 102. The compiler 108 determines which performance indicators from a network element are to be obtained and tracked, such as upload speed, download speed, upload throughput, download throughput, dropped calls, attach failures, etc. The compiler 108 determines rules for generating performance indicators (key performance indicators). The rules may be used to combine more than one item from a network element into a single performance indicator (e.g., 3 different data value types may be combined to determine if a dropped call occurred). The compiler 108 pulls performance indicator details in from the network elements, and feeds the performance indicator details into a network element compiler. The network element compiler of the compiler 108 generates packages used to process performance indicators records. A file (e.g., a jar file) is generated with the packages and is injected into the normalizer 130.

Injection may be performed in various manners depending on the implementation. In some implementations it may be achieved through storing the file in a storage that is accessible to the normalizer, such that it may incorporate the package. In some embodiments that use container-enabled infrastructure to implement the system components, the injection may occur through providing the results from the complier 108 to a Kubernetes configmap. Once the configmap is updated, an event is sent to all pods using the configmap, which allows the pods to incorporate the compiler results. In some embodiments, the injection occurs where the information is placed into a new image in a network-accessible repository. A service mesh may be used to start pods having containers that will incorporate the new image. Over time, as the operation of the new pods that incorporate the new information is validated, existing pods may be replaced with new pods, which may be useful for major releases such as where a new network element is added with complex rules.

The compiler 108 specifies aggregation windows (e.g., rollups of 1 minute, 15 minutes, hourly, daily, etc.). For certain network elements (e.g., legacy network elements), the compiler configures a job to pull files from the network elements in order to place the files into a message bus. For other network elements, an application may be installed within a network element to place performance indicators onto the data delivery component (in this example, a message bus). The normalizer 130 is configured to automatically identify new packages for new network elements, and start processing performance indicator data from the new network elements. The normalizer also performs aggregation and stores the aggregated performance indicator data/records into persistent storage such as a table of a database.

As illustrated by FIG. 1B, the normalizer 130 receives input such as the packages from the compiler 108. The normalizer 130 connects to a message bus 132 from the network elements for receiving performance indicator data (e.g., performance indicator data published as messages that can be subscribed to by the normalizer 130). The normalizer 130 connects to a message bus 136 from network elements (e.g., legacy network elements) that utilize file storage in order to pull files 134 of performance indicator data from the file storage. The normalizer 130 may selectively store incoming performance indicator data as performance indicator records within persistent storage such as a database 138, file based storage 140, cloud storage 142, etc. In some implementations, the data delivery component may use other mechanisms to enable data transfer from the network elements.

In some embodiments, the normalizer 130 performs various functions such as pulling messages of performance indicator data from the message bus. The normalizer 130 may perform normalization on the performance indicator data before storing the performance indicator data into a database serving layer. The performance indicator data may also be stored into file storage so that the performance indicator data can be aggregated (e.g., summations and counts) over aggregation windows. If there is an outage or failure, the performance indicator data is already persisted on a file system of the file storage so that the performance indicator data can continue to be processed such as through a failover process where a different instance of the platform takes over for a failed instance of the platform. The normalizer 130 may group performance indicators by market, sector, carrier, and/or base station type (eNB 4g, gNB 5g, etc.). Such groupings provide the platform with the ability to correlate (tie together) performance indicator data from different network elements. Because locational information (e.g., latitude and longitude) may be stored with the performance indicator data, devices (e.g., user equipment) can be tracked as the devices move in and out of different markets, sectors, carriers, and base stations. A reference table may be generated to map devices to home groups.

The normalizer 130 checks for newly installed compiler objects that the compiler 108 dynamically injected into the normalizer 130 through one or more packages. The normalizer 130 checks for new message streams through which messages of performance indicator data are published over a message bus (e.g. “topics”) so that the normalizer 130 can read the performance indicator data over the message bus from the network elements. The normalizer 130 reads a topic that is mapped to one or more compiler objects in order to receive performance indicators to store into a database or other persistent storage. The normalizer 130 may perform one or more transformations (cleanups) on the performance indicator data based upon rules provided by the compiler 108, such as converting string dates to database timestamps, converting string double values to doubles, converting data into a format and data type supported by cells within a database table, etc. In this way, the normalizer 130 stores the data into the database.

As illustrated by FIG. 1C, the normalizer 130 may inform an aggregator 152 to perform aggregations upon the performance indicator data that may be stored by the compiler 108 into file based storage 150 for processing by the aggregator 152. The aggregator 152 may aggregate (rollup) the performance indicator data stored within the file based storage according to aggregation windows such as a 1 minute aggregation window 154, a 15 minutes aggregation window 156, an hourly aggregation window 158, a daily aggregation window 160, or any other aggregation timeframe. The aggregator 152 aggregates the performance indicator data to create aggregate performance indicator sets that are stored within destination data storage 162.

During operation of the platform, the compiler 108, the normalizer 130, and/or the aggregator 152 may check to see if there are any new network elements and/or types of performance indicators to track, along with new rules for processing performance indicator data. In this way, the platform may dynamically adjust to new network elements, performance indicators, and/or rules during continued operation of the platform and without having the re-deploy the platform or create code modifications.

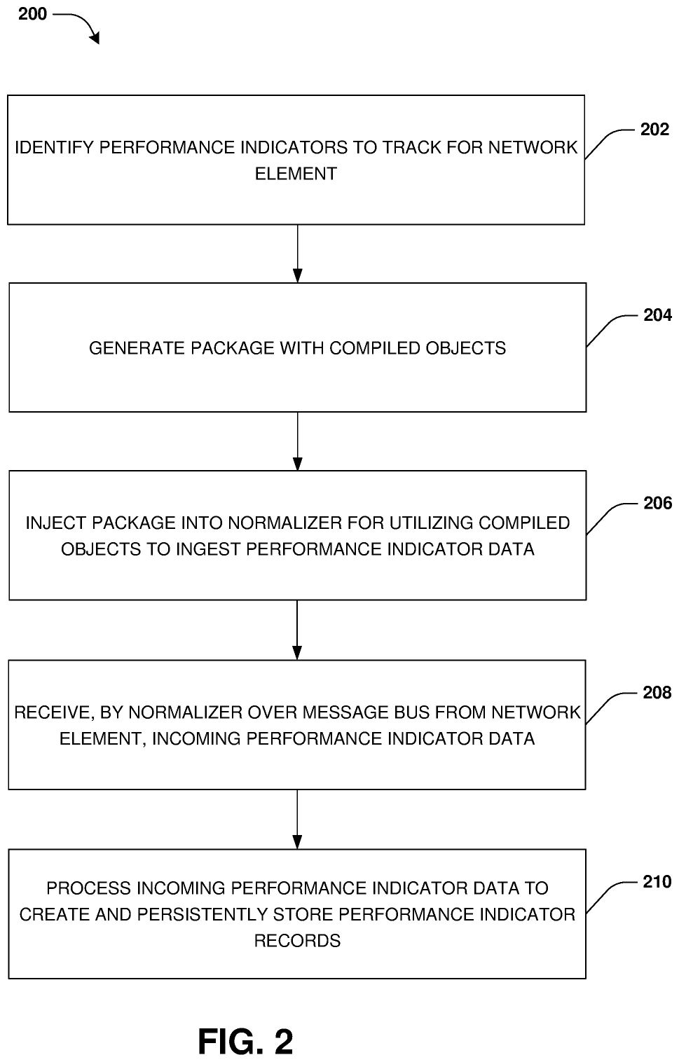

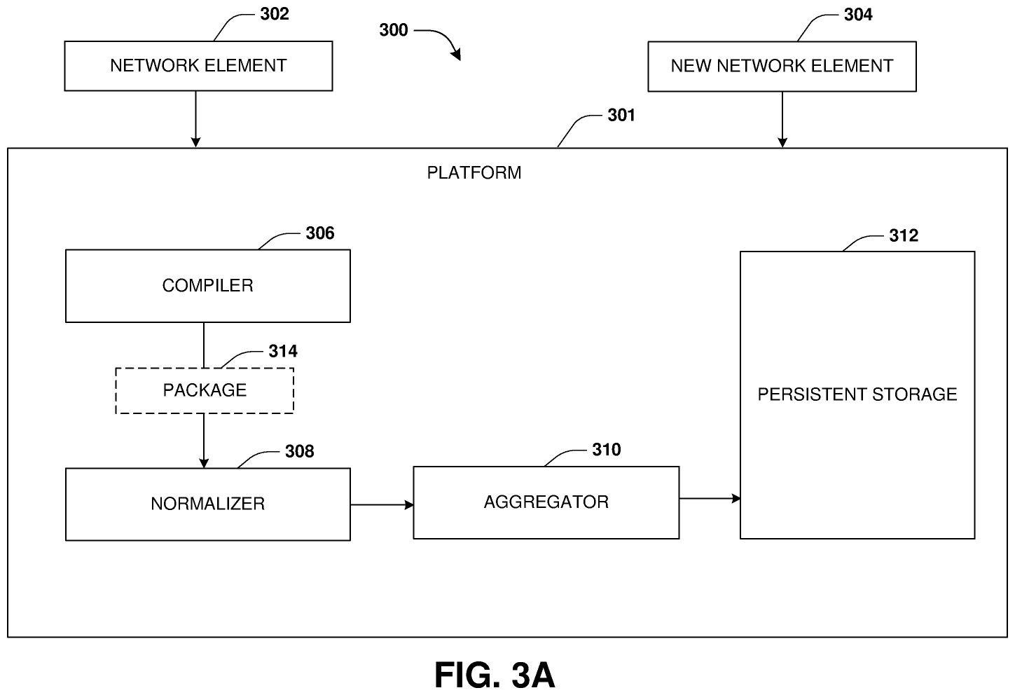

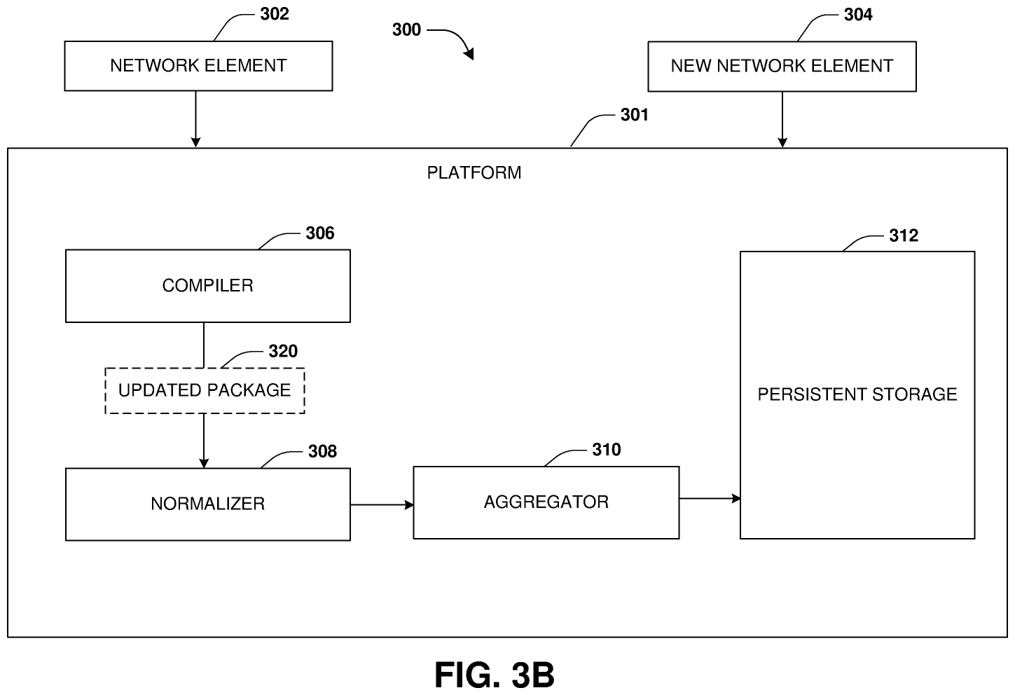

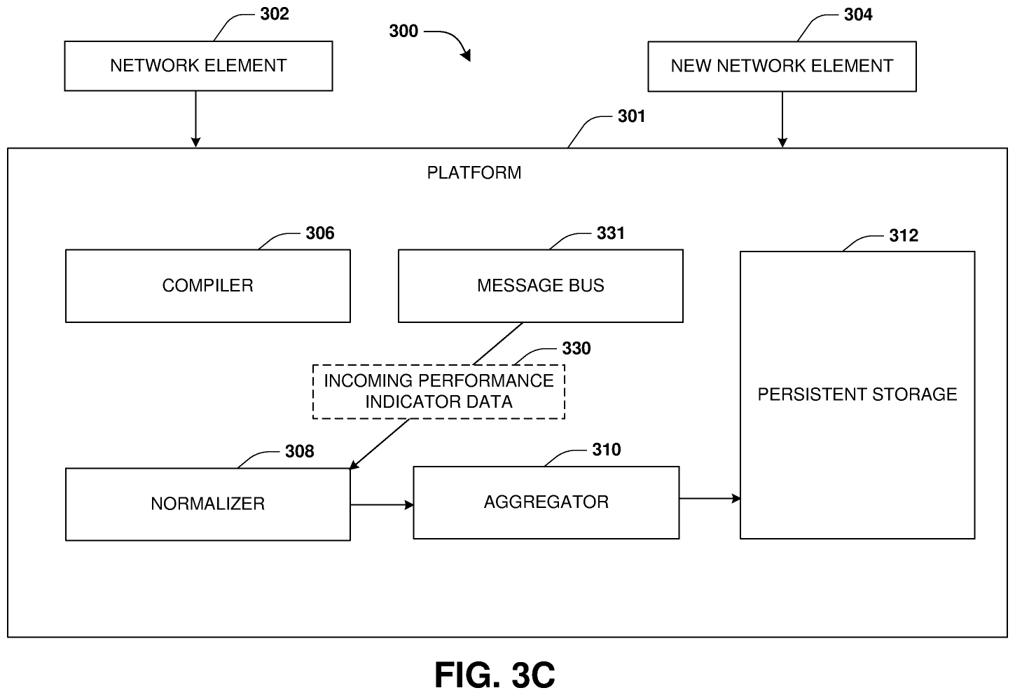

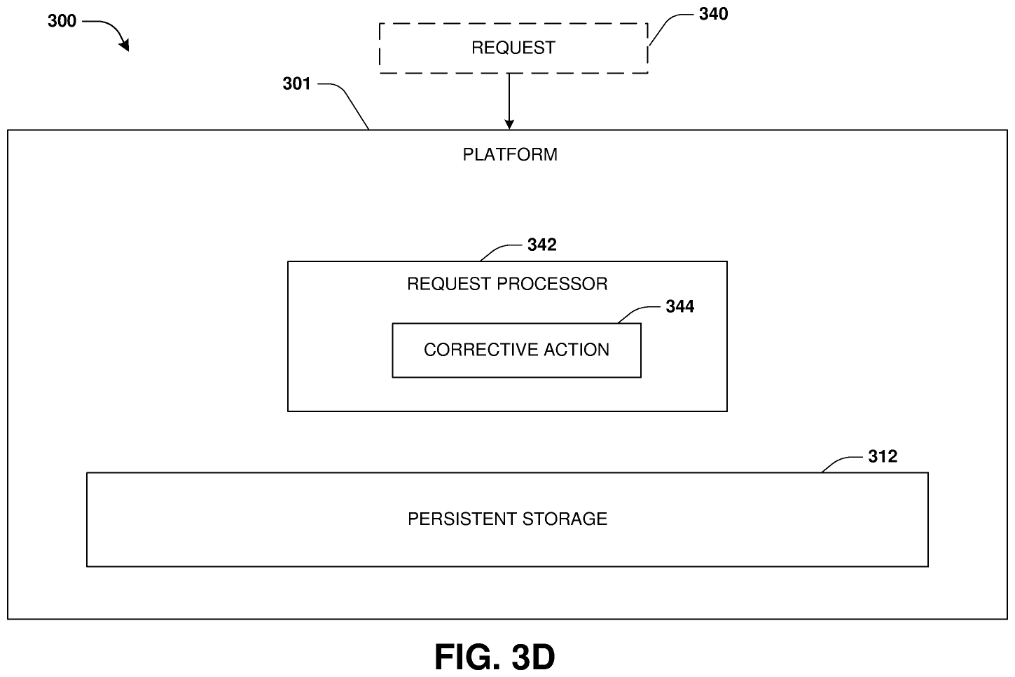

FIG. 2 is a flow chart illustrating an example method 200 for performance indicator acquisition and processing for a communication network, which is illustrated in conjunction with system 300 of FIGS. 3A-3D. A platform 301 may be hosted on one or more computing devices, and includes a compiler 306, a normalizer 308, and/or an aggregator 310, as illustrated by FIG. 3A. In some embodiments, the platform 301 utilizes persistent storage 312 (e.g., file based storage, a database, cloud storage, etc.). The persistent storage 312 may be hosted by the platform 301 and/or may be hosted separate and remote from the platform 301. The platform 301 may be configured to acquire performance indicator data from network elements such as a network element 302, and store the performance indicator data within the persistent storage 312.

During operation of the platform 301 (e.g., while the compiler 306, normalizer 308, and/or aggregator 310 are processing incoming performance indicator data from the network element 302), the platform 301 may onboard a new network element 304 for tracking certain performance indicators. During operation 202 of method 200, performance indicators that are to be tracked for the new network element 304 of the communication network are identified. In some embodiments, the performance indicators may be user specified or may be mapped to a network element type of the new network element 304 (e.g., cell towers may be mapped to certain performance indicators indicative of performance and operation of the cell towers, while other network elements may be mapped to other types of performance indicators indicative of performance and operation of those types of network elements).

During operation 204 of method 200, the compiler 306 generates a package 314 with compiler objects specifying how the normalizer 308 is to process performance indicator data from the new network element 304 for generating performance indicator records to store within the persistent storage 312. The compiler objects may include database objects, marshaling objects, serializer objects, database schemas, object container file format objects, and/or other types of objects.

During operation 206 of method 200, the compiler 306 injects the package 314 into the normalizer 308 so that the normalizer 308 can utilize the compiler objects to ingest the performance indicator data. In some embodiments, a compiler object is mapped to a particular type of performance indicator data to be processed by that particular compiler object (e.g., a certain database schema is to be used for a particular type of performance indicator data). In some embodiments, the normalizer 308 subscribes to topics used by a message bus 331 (depicted by FIG. 3C) to publish performance indicator data from network elements such as the new network element 304 to the normalizer 308 over the message bus 331. In some embodiments, the compiler objects may be mapped to the topics (e.g., a first compiler object may be mapped to a first topic over which a certain type of performance indicator data is to be received and processed by the first compiler object).

The compiler 306 is configured to dynamically modify what performance indicators are tracked by the normalizer 308 and/or what rules are used by the normalizer 308. The compiler 306 may determine that a new performance indicator is to be tracked for the new network element 304 or that an existing performance indicator is to be no longer tracked for the new network element 304. Accordingly, the compiler 306 creates an updated package 320 that is injected into the normalizer 308 during runtime operation of the normalizer 308 (without interrupting operation of the normalizer 308) for dynamically modifying what and how the normalizer 308 tracks performance indicators, as illustrated by FIG. 3B.

During operation 208 of method 200, the normalizer 308 receives incoming performance indicator data 330 over the message bus 331 from the new network element 304, as illustrated by FIG. 3C. In some embodiments, the incoming performance indicator data 330 is published through the topics subscribed to by the normalizer 308. In some embodiments, the incoming performance indicator data 330 is retrieved through a file pull operation from the new network element 304 (e.g., from file based storage used by a legacy network element), and the incoming performance indicator data 330 is published over the message bus 331 for access by the normalizer 308. In some embodiments, the normalizer 308 may utilize a rule to combine a set of data items from the new network element to create a single performance indicator (e.g., a dropped call key performance indicator may be represented or identified from multiple pieces of information stored as the set of data items).

During operation 210 of method 200, the incoming performance indicator data 330 is processed by the normalizer 308 using the compiler objects to create and persistently store performance indicator records within the persistent storage 312. The performance indicator records may be used to track download speeds, upload speeds, voice connections, text messaging, user equipment performance, cell tower performance, network equipment performance, and/or a wide variety of other key performance indicators and/or other operational/performance information.

The normalizer 308 may control the aggregator 310 to aggregate the performance indicator performance records over various aggregation windows to create aggregated performance sets that may be stored into the persistent storage 312. The aggregation windows may correspond to various time windows (timespans) such as 1 minute, 15 minutes, 30 minutes, hourly, daily, etc. The platform 301 may receive a request 340 for analyzing the communication network, as illustrated by FIG. 3D. The request 340 may relate to a troubleshooting request being handled by a call center, a service ticket to troubleshoot an issue, a request to evaluate voicemail access performance (e.g., identify a cause of a user being unable to access voicemail through user equipment), a request to evaluate text messaging performance (e.g., identify a cause of a user being unable to send or receive text messages through user equipment), a request to identify any failed or overloaded network components, etc. In some embodiments, the request 340 is received by a request processor 342 of the platform 301.

The request processor 342 determines a level of granularity of performance indicators that correspond to (e.g., are mapped to) the request 340. In some embodiments, a call center troubleshooting request may be mapped to a level of granularity corresponding to an aggregation of a 1 minute aggregation window so that real-time troubleshooting can be performed (e.g., real-time identified of an overloaded or failed cell tower that needs to be immediately addressed). In some embodiments, a service ticket request to evaluate voicemail access performance or text messaging performance may be mapped to a level of granularity corresponding to an hourly aggregation window or a daily aggregation window that provides a view of performance indicator data that can help troubleshoot voicemail or text messaging issues that may occur over hours or days. The level of granularity of performance indicator data is used to select a corresponding aggregated performance indicator set corresponding to an aggregation window specified by the level of granularity. In some embodiments, an aggregated performance indicator set may be provided back to a requestor in response to the request 340. In some embodiments, the aggregated performance indicator set is analyzed to generate a corrective action 344 to address an issue identified by the analysis of the aggregated performance indicator set. The corrective action 344 may be executed such as by transmitting a command to a network element within the communication network to modify operation of the network element (e.g., a command to reroute connection requests from a failed or overloaded cell tower to a different cell tower) in order to improve operation of the communication network.

According to some embodiments, a method is provided. The method includes identifying performance indicators to track for a network element of a communication network; generating, by a compiler, a package with compiler objects specifying how a normalizer is to process performance indicator data from the network element to generate performance indicator records; injecting the package into the normalizer for utilizing the compiler objects to ingest the performance indicator data that is subscribed to through topics by the normalizer, wherein the compiler objects are mapped to the topics; receiving, by the normalizer over a message bus from the network element, incoming performance indicator data published through the topics; and processing, utilizing the compiler objects, the incoming performance indicator data to create and persistently store the performance indicator records.

According to some embodiments, the method includes utilizing a rule to combine a set of data items from the network element to create a single performance indicator.

According to some embodiments, the method includes dynamically modifying the performance indicators to track by removing or adding a performance indicator during operation of the normalizer.

According to some embodiments, the method includes aggregating the performance indicator records over an aggregation window to create aggregated performance indicator sets; in response to receiving a request for analyzing the communication network, selecting an aggregated performance indicator set corresponding to a level of granularity related to the request; and providing the aggregated performance indicator set as a response to the request.

According to some embodiments, the method includes in response to determining that a performance indicator is no longer to be tracked, generating an updated package with updated compiler objects; and injecting the updated package into the normalizer to stop tracking the performance indicator.

According to some embodiments, the method includes in response to determining that a performance indicator is to be tracked, generating an updated package with updated compiler objects; and injecting the updated package into the normalizer to start tracking the performance indicator

According to some embodiments, the method includes receiving a troubleshooting request for the communication network; selecting a level of granularity of performance indicator data to analyze for the troubleshooting request; selecting an aggregated performance indicator set corresponding to the level of granularity; analyzing the aggregated performance indicator set to generate a corrective action to perform for the troubleshooting request; and implementing the corrective action.

According to some embodiments, the method includes dynamically configuring, by the compiler during operation of a platform that includes the compiler and the normalizer, the normalizer to track a set of performance indicators for a new network element.

According to some embodiments, the method includes aggregating the performance indicator records over an aggregation window to create an aggregated performance indicator set; and in response to receiving performance data within a threshold time after creation of the aggregated performance indicator set, adding the performance data into the aggregated performance indicator set.

According to some embodiments, the method includes transforming, by the normalizer, the incoming performance indicator data utilizing rules provided by the compiler to the normalizer.

According to some embodiments, a system comprising one or more processors configured for executing the instructions to perform operations, is provided. The operations identifying performance indicators to track for a network element of a communication network; generating, by a compiler, a package with compiler objects specifying how a normalizer is to process performance indicator data from the network element to generate performance indicator records; injecting the package into the normalizer for utilizing the compiler objects to ingest the performance indicator data, wherein a compiler object is mapped to a type of performance indicator data to be processed by the compiler object; receiving, by the normalizer over a message bus from the network element, incoming performance indicator data; and processing, utilizing the compiler objects, the incoming performance indicator data to create and persistently store the performance indicator records.

According to some embodiments, the operations further include performing a file pull operation to retrieve the incoming performance indicator data from the network element and publish the incoming performance indicator data over the message bus.

According to some embodiments, the operations further include processing the performance indicator records to track at least one of download speeds, upload speeds, voice connections, text messaging, user equipment performance, cell tower performance, or network equipment performance.

According to some embodiments, the operations further include dynamically configuring, by the compiler during operation of a platform that includes the compiler and the normalizer, the normalizer to track a set of performance indicators for a new network element.

According to some embodiments, the operations further include aggregating performance indicator records over a first aggregation window to create a first aggregated performance indicator set; and utilizing the first aggregated performance indicator set to troubleshoot a service request.

According to some embodiments, the operations further include aggregating performance indicator records over a second aggregation window to create a second aggregated performance indicator set; and utilizing the second aggregated performance indicator set to evaluate text messaging performance.

According to some embodiments, the operations further include aggregating performance indicator records over a second aggregation window to create a second aggregated performance indicator set; and utilizing the second aggregated performance indicator set to evaluate voicemail access performance.

According to some embodiments, a non-transitory computer-readable medium storing instructions that when executed facilitate performance of operations, is provided. The operations include identifying performance indicators to track for a network element of a communication network; generating, by a compiler, a package with compiler objects specifying how a normalizer is to process performance indicator data from the network element to generate performance indicator records; injecting the package into the normalizer for utilizing the compiler objects to ingest the performance indicator data, wherein a compiler object is mapped to a type of performance indicator data to be processed by the compiler object; receiving, by the normalizer over a message bus from the network element, incoming performance indicator data; and processing, utilizing the compiler objects, the incoming performance indicator data to create and persistently store the performance indicator records.

According to some embodiments, the operations further include dynamically configuring, by the compiler during operation of a platform that includes the compiler and the normalizer, the normalizer to track a set of performance indicators for a new network element.

According to some embodiments, the operations further include dynamically modifying the performance indicators to track by removing or adding a performance indicator during operation of a platform that includes the compiler and the normalizer.

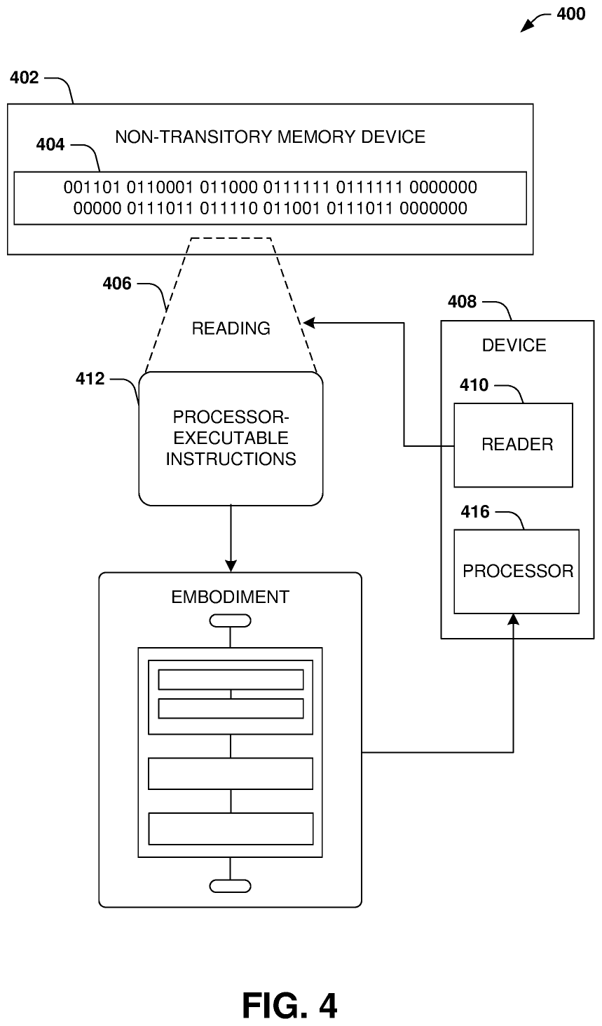

FIG. 4 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 200 of FIG. 2, for example. In some embodiments, the processor-executable instructions 412 are configured to cause implementation of a system, such as at least some of the example system 100 of FIGS. 1A-1C and/or at least some of the example systems 300 of FIGS. 3A-3C.

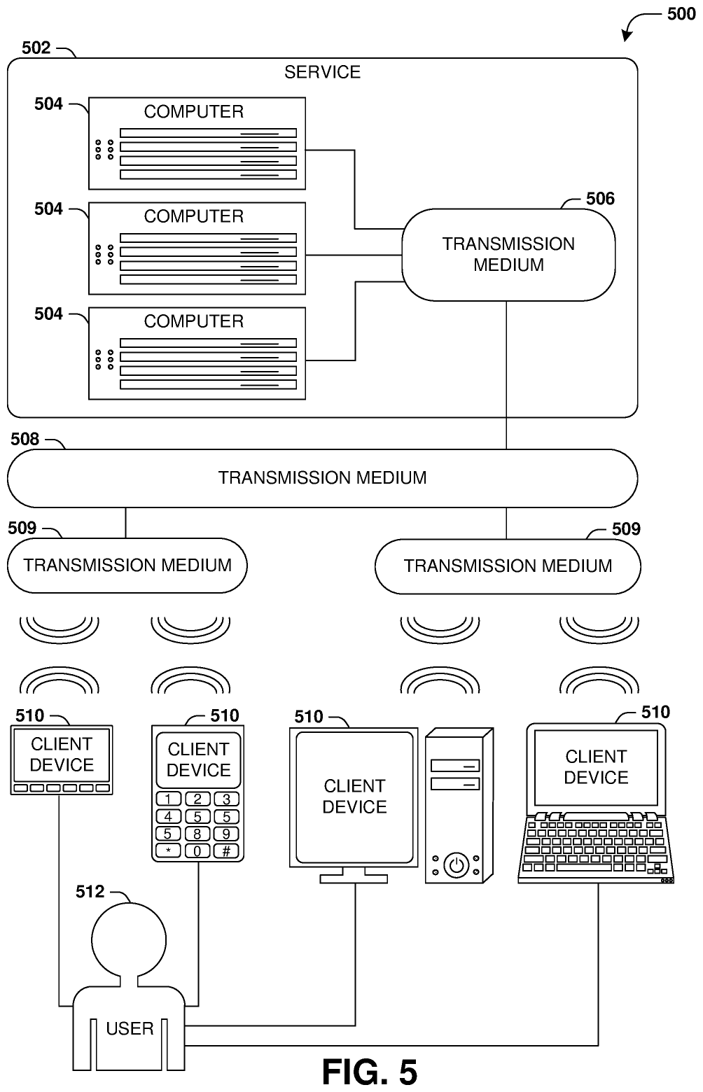

FIG. 5 is an interaction diagram of a scenario 500 illustrating a service 502 provided by a set of computers 504 to a set of client devices 510 via various types of transmission mediums. The computers 504 and/or client devices 510 may be capable of transmitting, receiving, processing, and/or storing many types of signals, such as in memory as physical memory states.

In some embodiments, the computers 504 may be host devices and/or the client device 510 may be devices attempting to communicate with the computer 504 over buses for which device authentication for bus communication is implemented.

The computers 504 of the service 502 may be communicatively coupled together, such as for exchange of communications using a transmission medium 506. The transmission medium 506 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 502.

Likewise, the transmission medium 506 may comprise one or more sub-networks, such as may employ different architectures, may be compliant or compatible with differing protocols and/or may interoperate within the transmission medium 506. Additionally, various types of transmission medium 506 may be interconnected (e.g., a router may provide a link between otherwise separate and independent transmission medium 506).

In scenario 500 of FIG. 5, the transmission medium 506 of the service 502 is connected to a transmission medium 508 that allows the service 502 to exchange data with other services 502 and/or client devices 510. The transmission medium 508 may encompass various combinations of devices with varying levels of distribution and exposure, such as a public wide-area network and/or a private network (e.g., a virtual private network (VPN) of a distributed enterprise).

In the scenario 500 of FIG. 5, the service 502 may be accessed via the transmission medium 508 by a user 512 of one or more client devices 510, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 510 may communicate with the service 502 via various communicative couplings to the transmission medium 508. As a first such example, one or more client devices 510 may comprise a cellular communicator and may communicate with the service 502 by connecting to the transmission medium 508 via a transmission medium 509 provided by a cellular provider. As a second such example, one or more client devices 510 may communicate with the service 502 by connecting to the transmission medium 508 via a transmission medium 509 provided by a location such as the user's home or workplace (e.g., a Wi-Fi (Institute of Electrical and Electronics Engineers (IEEE) Standard 602.11) network or a Bluetooth (IEEE Standard 602.15.1) personal area network). In this manner, the computers 504 and the client devices 510 may communicate over various types of transmission mediums.

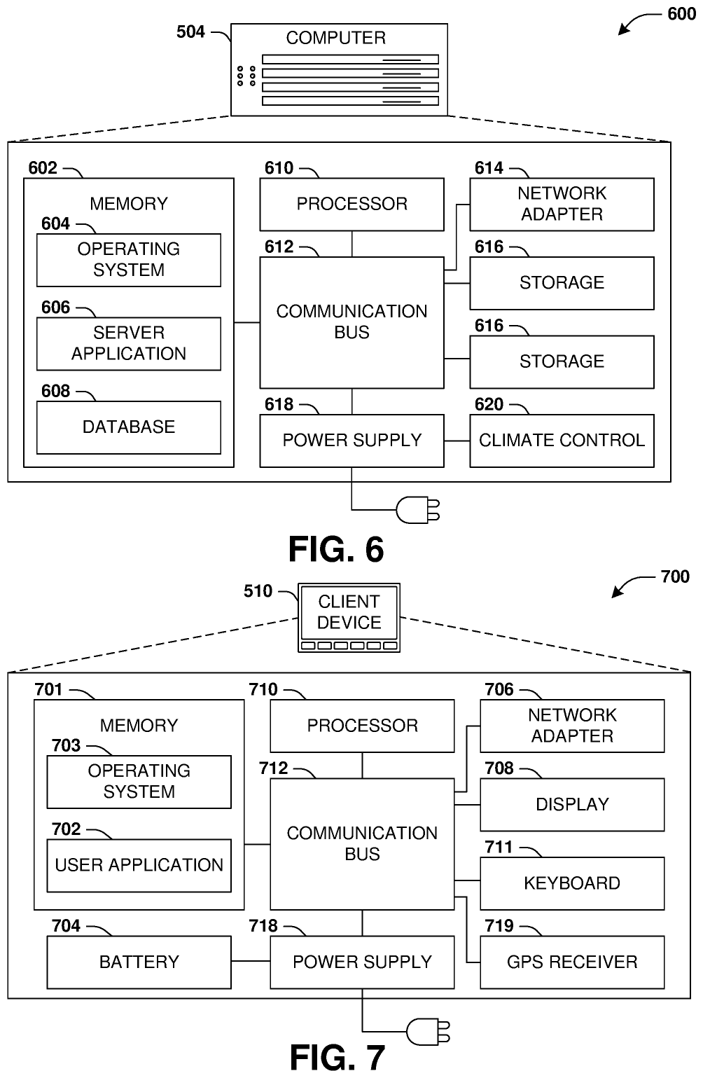

FIG. 6 presents a schematic architecture diagram 600 of a computer 604 that may utilize at least a portion of the techniques provided herein. Such a computer 604 may vary widely in configuration or capabilities, alone or in conjunction with other computers, in order to provide a service.

The computer 604 may comprise one or more processors 610 that process instructions. The one or more processors 610 may optionally include a plurality of cores; one or more coprocessors, such as a mathematics coprocessor or an integrated graphical processing unit (GPU); and/or one or more layers of local cache memory. The computer 604 may comprise memory 602 storing various forms of applications, such as an operating system 604; one or more computer applications 606; and/or various forms of data, such as a database 608 or a file system. The computer 604 may comprise a variety of peripheral components, such as a wired and/or wireless network adapter 614 connectible to a local area network and/or wide area network; one or more storage components 616, such as a hard disk drive, a solid-state storage device (SSD), a flash memory device, and/or a magnetic and/or optical disk reader.

The computer 604 may comprise a mainboard featuring one or more communication buses 612 that interconnect the processor 610, the memory 602, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 612 may interconnect the computer 604 with at least one other computer. Other components that may optionally be included with the computer 604 (though not shown in the schematic architecture diagram 600 of FIG. 6) include a display; a display adapter, such as a graphical processing unit (GPU); input peripherals, such as a keyboard and/or mouse; and a flash memory device that may store a basic input/output system (BIOS) routine that facilitates booting the computer 604 to a state of readiness.

The computer 604 may operate in various physical enclosures, such as a desktop or tower, and/or may be integrated with a display as an “all-in-one” device. The computer 604 may be mounted horizontally and/or in a cabinet or rack, and/or may simply comprise an interconnected set of components. The computer 604 may comprise a dedicated and/or shared power supply 618 that supplies and/or regulates power for the other components. The computer 604 may provide power to and/or receive power from another computer and/or other devices. The computer 604 may comprise a shared and/or dedicated climate control unit 620 that regulates climate properties, such as temperature, humidity, and/or airflow. Many such computers 604 may be configured and/or adapted to utilize at least a portion of the techniques presented herein.

FIG. 7 presents a schematic architecture diagram 700 of a client device 510 whereupon at least a portion of the techniques presented herein may be implemented. Such a client device 510 may vary widely in configuration or capabilities, in order to provide a variety of functionality to a user such as the user 512. The client device 510 may be provided in a variety of form factors, such as a desktop or tower workstation; an “all-in-one” device integrated with a display 708; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 510 may serve the user in a variety of roles, such as a workstation, kiosk, media player, gaming device, and/or appliance.

The client device 510 may comprise one or more processors 710 that process instructions. The one or more processors 710 may optionally include a plurality of cores; one or more coprocessors, such as a mathematics coprocessor or an integrated graphical processing unit (GPU); and/or one or more layers of local cache memory. The client device 510 may comprise memory 701 storing various forms of applications, such as an operating system 703; one or more user applications 702, such as document applications, media applications, file and/or data access applications, communication applications such as web browsers and/or email clients, utilities, and/or games; and/or drivers for various peripherals. The client device 510 may comprise a variety of peripheral components, such as a wired and/or wireless network adapter 706 connectible to a local area network and/or wide area network; one or more output components, such as a display 708 coupled with a display adapter (optionally including a graphical processing unit (GPU)), a sound adapter coupled with a speaker, and/or a printer; input devices for receiving input from the user, such as a keyboard 711, a mouse, a microphone, a camera, and/or a touch-sensitive component of the display 708; and/or environmental sensors, such as a global positioning system (GPS) receiver 719 that detects the location, velocity, and/or acceleration of the client device 510, a compass, accelerometer, and/or gyroscope that detects a physical orientation of the client device 510. Other components that may optionally be included with the client device 510 (though not shown in the schematic architecture diagram 700 of FIG. 7) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 510 to a state of readiness; and a climate control unit that regulates climate properties, such as temperature, humidity, and airflow.

The client device 510 may comprise a mainboard featuring one or more communication buses 712 that interconnect the processor 710, the memory 701, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 510 may comprise a dedicated and/or shared power supply 718 that supplies and/or regulates power for other components, and/or a battery 704 that stores power for use while the client device 510 is not connected to a power source via the power supply 718. The client device 510 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
identifying performance indicators to track for a network element of a communication network;
generating, by a compiler, a package with compiler objects specifying how a normalizer is to process performance indicator data from the network element to generate performance indicator records;
injecting the package into the normalizer for utilizing the compiler objects to ingest the performance indicator data that is subscribed to through topics by the normalizer, wherein the compiler objects are mapped to the topics;
receiving, by the normalizer over a message bus from the network element, incoming performance indicator data published through the topics; and
processing, utilizing the compiler objects, the incoming performance indicator data to create and persistently store the performance indicator records.

2. The method of claim 1, comprising:
utilizing a rule to combine a set of data items from the network element to create a single performance indicator.

3. The method of claim 1, comprising:
dynamically modifying the performance indicators to track by removing or adding a performance indicator during operation of the normalizer.

4. The method of claim 1, comprising:
aggregating the performance indicator records over an aggregation window to create aggregated performance indicator sets;
in response to receiving a request for analyzing the communication network, selecting an aggregated performance indicator set corresponding to a level of granularity related to the request; and
providing the aggregated performance indicator set as a response to the request.

5. The method of claim 1, comprising:
in response to determining that a performance indicator is no longer to be tracked, generating an updated package with updated compiler objects; and
injecting the updated package into the normalizer to stop tracking the performance indicator.

6. The method of claim 1, comprising:
in response to determining that a performance indicator is to be tracked, generating an updated package with updated compiler objects; and
injecting the updated package into the normalizer to start tracking the performance indicator.

7. The method of claim 1, comprising:
receiving a troubleshooting request for the communication network;
selecting a level of granularity of performance indicator data to analyze for the troubleshooting request;
selecting an aggregated performance indicator set corresponding to the level of granularity;
analyzing the aggregated performance indicator set to generate a corrective action to perform for the troubleshooting request; and
implementing the corrective action.

8. The method of claim 1, comprising:
dynamically configuring, by the compiler during operation of a platform that includes the compiler and the normalizer, the normalizer to track a set of performance indicators for a new network element.

9. The method of claim 1, comprising:
aggregating the performance indicator records over an aggregation window to create an aggregated performance indicator set; and
in response to receiving performance data within a threshold time after creation of the aggregated performance indicator set, adding the performance data into the aggregated performance indicator set.

10. The method of claim 1, comprising:
transforming, by the normalizer, the incoming performance indicator data utilizing rules provided by the compiler to the normalizer.

11. A system, comprising:
one or more processors configured for executing instructions to perform operations comprising:
identifying performance indicators to track for a network element of a communication network;
generating, by a compiler, a package with compiler objects specifying how a normalizer is to process performance indicator data from the network element to generate performance indicator records;
injecting the package into the normalizer for utilizing the compiler objects to ingest the performance indicator data, wherein a compiler object is mapped to a type of performance indicator data to be processed by the compiler object;
receiving, by the normalizer over a message bus from the network element, incoming performance indicator data; and
processing, utilizing the compiler objects, the incoming performance indicator data to create and persistently store the performance indicator records.

12. The system of claim 11, wherein the operations further comprise:
performing a file pull operation to retrieve the incoming performance indicator data from the network element and publish the incoming performance indicator data over the message bus.

13. The system of claim 11, wherein the operations further comprise:
processing the performance indicator records to track at least one of download speeds, upload speeds, voice connections, text messaging, user equipment performance, cell tower performance, or network equipment performance.

14. The system of claim 11, wherein the operations comprise:
dynamically configuring, by the compiler during operation of a platform that includes the compiler and the normalizer, the normalizer to track a set of performance indicators for a new network element.

15. The system of claim 11, wherein the operations further comprise:
aggregating performance indicator records over a first aggregation window to create a first aggregated performance indicator set; and
utilizing the first aggregated performance indicator set to troubleshoot a service request.

16. The system of claim 11, wherein the operations further comprise:
aggregating performance indicator records over a second aggregation window to create a second aggregated performance indicator set; and
utilizing the second aggregated performance indicator set to evaluate text messaging performance.

17. The system of claim 11, wherein the operations further comprise:
aggregating performance indicator records over a second aggregation window to create a second aggregated performance indicator set; and
utilizing the second aggregated performance indicator set to evaluate voicemail access performance.

18. A non-transitory computer-readable medium storing instructions that when executed facilitate performance of operations comprising:
identifying performance indicators to track for a network element of a communication network;
generating, by a compiler, a package with compiler objects specifying how a normalizer is to process performance indicator data from the network element to generate performance indicator records;
injecting the package into the normalizer for utilizing the compiler objects to ingest the performance indicator data, wherein a compiler object is mapped to a type of performance indicator data to be processed by the compiler object;
receiving, by the normalizer over a message bus from the network element, incoming performance indicator data; and
processing, utilizing the compiler objects, the incoming performance indicator data to create and persistently store the performance indicator records.

19. The non-transitory computer-readable medium of claim 18, wherein the operations further comprise:
dynamically configuring, by the compiler during operation of a platform that includes the compiler and the normalizer, the normalizer to track a set of performance indicators for a new network element.

20. The non-transitory computer-readable medium of claim 18, wherein the operations further comprise:
dynamically modifying the performance indicators to track by removing or adding a performance indicator during operation of a platform that includes the compiler and the normalizer.
